(19) United States
(12) Patent Application Publication
(10) Pub. No.: US 2025/0197972 A1
(43) Pub. Date: Jun. 19, 2025

(54) COPPER-NICKEL-SILICON ALLOYS WITH HIGH STRENGTH AND HIGH ELECTRICAL CONDUCTIVITY

(71) Applicant: MATERION CORPORATION, Mayfield Heights, OH (US)

(72) Inventors: Carole L. TRYBUS, Mayfield Heights, OH (US); John C. KULI, Mayfield Heights, OH (US); Christopher J. TAYLOR, Mayfield Heights, OH (US)

(73) Assignee: MATERION CORPORATION, Mayfield Heights, OH (US)

(21) Appl. No.: 19/071,327

(22) Filed: Mar. 5, 2025

Related U.S. Application Data
(62) Division of application No. 17/259,710, filed on Jan. 12, 2021, now abandoned.
(60) Provisional application No. 62/696,915, filed on Jul. 12, 2018.

(51) Int. Cl. C22C 9/06; C22F 1/00; C22F 1/08

(52) U.S. Cl. CPC C22C 9/06; C22F 1/002; C22F 1/08

(57) ABSTRACT

A copper alloy that does not contain beryllium and has a 0.2% offset yield strength of at least 80 ksi and an electrical conductivity of at least 48% IACS is disclosed. The copper alloy contains nickel, silicon, chromium, manganese, zirconium, and balance copper. The alloy is prepared by cold working, solution annealing, and aging. The alloy can be used, for example, as a heat sink.

### CROSS-REFERENCE TO RELATED APPLICATIONS

This application claims priority to U.S. Provisional Patent Application Ser. No. 62/696,915, filed Jul. 12, 2018, the entirety of which is incorporated by reference herein.

### BACKGROUND

The present disclosure relates to copper alloys with a combination of high yield strength and high electrical conductivity. Processes for making and using such alloys are also disclosed, as well as articles produced therefrom.

Copper alloys with a combination of relatively high 0.2% offset yield strength and high electrical/thermal conductivity are difficult to achieve. Copper-beryllium alloys have such properties, but there are many applications in which the presence of beryllium is undesirable. Hence, there is a need for additional copper alloys having such desired characteristics amongst others.

### BRIEF DESCRIPTION

Disclosed herein are copper-nickel-silicon alloys with a combination of high 0.2% offset yield strength and high electrical/thermal conductivity. The alloys contain at least nickel, silicon, chromium, manganese, zirconium, and copper. Desirably, the alloys do not contain beryllium and/or other certain metals. The alloys are cold worked and then solution annealed to produce fine grain sizes, then aged to form a variety of precipitates such as NiSi and CrZrSi precipitates. This creates a dislocation network with precipitates that come out on the grain boundaries, locking in the fine grain sizes. In particular embodiments, the alloys have a 0.2% offset yield strength of at least 80 ksi and an electrical conductivity of at least 48% IACS. Such alloys are useful in applications such as heat management and as high strength and performance electrical connectors, among others.

Disclosed herein in various embodiments are copper alloys, comprising: from about 1.0 wt % to about 4 wt % nickel; from about 0.2 wt % to about 2 wt % silicon; from about 0.1 wt % to about 1 wt % chromium; from about 0.05 wt % to about 0.5 wt % manganese; from about 0.01 wt % to about 0.2 wt % zirconium; and balance copper; wherein the alloy has a 0.2% offset yield strength of at least 80 ksi and a conductivity of at least 48% IACS.

In particular embodiments, the alloys comprise: about 1.2 wt % to about 1.4 wt % nickel; about 0.3 wt % to about 0.4 wt % silicon; about 0.25 about 0.3 wt % to about 0.4 wt % chromium; about 0.08 wt % to about 0.12 wt % manganese; about 0.02 wt % to about 0.06 wt % zirconium; and balance copper.

The copper alloys generally do not contain beryllium, titanium, iron, cobalt, magnesium, or boron.

The copper alloys may have an ultimate tensile strength of at least 88 ksi. The copper alloys may have an elastic modulus of at least 20 million psi. The copper alloys may have a % total elongation of at least 8%. The copper alloys may have a ductility of at least 5% to about 15%. The copper alloys may have a formability ratio of 0.4/1 or lower. The copper alloys may contain silicides formed from silicon, chromium, nickel, and manganese.

In some embodiments, the copper alloys have a 0.2% offset yield strength of at least 80 ksi, a conductivity of at least 48% IACS, and a % TE of at least 8%.

In other embodiments, the copper alloys have a 0.2% offset yield strength of at least 80 ksi, a conductivity of at least 49% IACS, and an ultimate tensile strength of at least 90 ksi.

Also disclosed herein are processes for making a copper alloy that does not contain beryllium and has a 0.2% offset yield strength of at least 80 ksi and a conductivity of at least 48% IACS. The processes comprise: cold working a copper-nickel-silicon-chromium-manganese-zirconium alloy to a percentage of cold working (% CW) of about 80% to about 95%; solution annealing the cold-worked copper-nickel-silicon-chromium-manganese-zirconium alloy; and aging the solution-annealed copper-nickel-silicon-chromium-manganese-zirconium alloy to obtain the copper alloy with a 0.2% offset yield strength of at least 80 ksi and a conductivity of at least 48% IACS.

The solution annealing may be performed at a temperature of about 900° C. to about 1000°° C. for a time period of about 5 minutes to about 20 minutes.

The aging may be performed at a temperature of about 400° C. to about 460° C. for a time period of about 6 hours to about 60 hours. In more specific embodiments, the aging is performed at a temperature of about 400°° C. to about 460° C. for a time period of about 6 hours to about 18 hours. The copper alloys formed by these processes are also disclosed.

Also disclosed herein are articles formed from a copper-nickel-silicon-chromium-manganese-zirconium alloy, wherein the alloy has a 0.2% offset yield strength of at least 80 ksi and a conductivity of at least 48% IACS.

Amongst other things, the article can be a heat sink; an electrical connector; an electronic connector; a wiring harness terminal; an electric vehicle charger contact; a high voltage/current/power terminal contact; a power connector contact; a midplane connector; a backplane connector; a card edge connector; a photovoltaic system connector; an appliance power contact; a computer power contact; a heat spreader; a bushing or bearing surface; or a component for an electronic device or an electrical device.

Also disclosed are processes of using a copper-nickel-silicon-chromium-manganese-zirconium alloy that has a 0.2% offset yield strength of at least 80 ksi and a conductivity of at least 48% IACS, comprising: stamping an article from a strip of the copper-nickel-silicon-chromium-manganese-zirconium alloy.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is an optical view of a copper-nickel-silicon-chromium-manganese-zirconium alloy.

FIG. 2 is an image of a copper-nickel-silicon-chromium-manganese-zirconium alloy obtained by backscattered-electron scanning electron microscopy (BSE SEM).

FIG. 3 is a graph representing the 0.2% offset yield strength in ksi on the left y-axis, and conductivity as a percentage of the International Annealed Copper Standard (% IACS) on the right y-axis, of a copper-nickel-silicon-chromium-manganese-zirconium alloy having been aged at 800° F. Samples were aged at time intervals, indicated on the x-axis, of 3, 6, 12, 18, and 24 hours, and measurements were taken after aging for each time interval. The left y-axis runs from 0 to 100 ksi at intervals of 10. The right y-axis runs from 0 to 60% IACS at intervals of 10.

FIG. 4 is a graph representing the 0.2% offset yield strength in ksi on the left y-axis, and conductivity in % IACS on the right y-axis, of a copper-nickel-silicon-chromium-manganese-zirconium alloy having been aged at 815° F. Samples were aged at time intervals, indicated on the x-axis, of 3, 6, 12, and 18 hours, and measurements were taken after aging for each time interval. The left y-axis runs from 0 to 100 ksi at intervals of 10. The right y-axis runs from 0 to 60% IACS at intervals of 10.

FIG. 5 is a graph representing the 0.2% offset yield strength in ksi on the left y-axis, and conductivity in % IACS on the right y-axis, of a copper-nickel-silicon-chromium-manganese-zirconium alloy having been aged at 825° F. Samples were aged at time intervals, indicated on the x-axis, of 3, 6, 12, and 18 hours, and measurements were taken after aging for each time interval. The left y-axis runs from 0 to 100 ksi at intervals of 10. The right y-axis runs from 0 to 60% IACS at intervals of 10.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number.

The present disclosure may refer to temperatures for certain process steps. It is noted that these generally refer to the temperature at which the heat source (e.g. furnace) is set, and do not necessarily refer to the temperature which must be attained by the material being exposed to the heat.

The present disclosure relates to copper alloys that contain nickel, silicon, chromium, manganese, and zirconium. Such alloys have a 0.2% offset yield strength of at least 80 ksi and a conductivity of at least 48% IACS, a combination of strength and electrical conductivity that is not readily available. This permits use in heat management applications. Desirably, the alloys are formable, stampable, and free of beryllium.

Nickel may be present in the copper alloys in an amount of from about 1.0 wt % to about 4 wt % nickel, including from about 1.0 wt % to about 2.0 wt %, or about 1.2 wt % to about 1.4 wt % nickel.

Silicon may be present in the copper alloys in an amount of from about 0.2 wt % to about 2 wt %, including from about 0.2 wt % to about 1 wt %, or from about 0.3 wt % to about 0.4 wt %.

Chromium may be present in the copper alloys in an amount of from about 0.1 wt % to about 1 wt %, including from about 0.1 wt % to about 0.4 wt %, or about 0.25 wt %, or from about 0.3 wt % to about 0.4 wt %.

Manganese may be present in the copper alloys in an amount of from about 0.05 wt % to about 0.5 wt %, including from about 0.05 wt % to about 0.2 wt %, or from about 0.08 wt % to about 0.12 wt %.

Zirconium may be present in the copper alloys in an amount of from about 0.01 wt % to about 0.4 wt %, including from about 0.01 wt % to about 0.15 wt %, or from about 0.10 wt % to about 0.4 wt %, or from about 0.02 wt % to about 0.06 wt %.

The balance of the copper alloy is copper, excluding impurities. Put another way, the copper is present in an amount of about 92.3 wt % to about 98.7 wt %, or at least 92 wt %, at least 94 wt %, or at least 96 wt %. Any combination of these amounts of each element is contemplated.

In some particular embodiments, the copper alloy comprises: from about 1.0 wt % to about 4 wt % nickel; from about 0.2 wt % to about 2 wt % silicon; from about 0.1 wt % to about 1 wt % chromium; from about 0.05 wt % to about 0.5 wt % manganese; from about 0.01 wt % to about 0.4 wt % zirconium; and balance copper.

In some particular embodiments, the copper alloy comprises: from about 1.0 wt % to about 2 wt % nickel; from about 0.2 wt % to about 1 wt % silicon; from about 0.1 wt % to about 0.4 wt % chromium; from about 0.05 wt % to about 0.2 wt % manganese; from about 0.1 wt % to about 0.4 wt % zirconium; and balance copper.

In some particular embodiments, the copper alloy comprises: from about 1.2 wt % to about 1.4 wt % nickel; from about 0.3 wt % to about 4 wt % silicon; from about 0.3 wt % to about 0.4 wt % chromium; from about 0.08 wt % to about 0.12 wt % manganese; from about 0.02 wt % to about 0.06 wt % zirconium; and balance copper.

In other specific embodiments, the copper alloy comprises: about 1.2 wt % nickel; about 0.4 wt % silicon; about 0.25 wt % chromium; about 0.08 wt % manganese; about 0.02 wt % zirconium; and balance copper.

The copper alloys may also have some impurities, but desirably do not. Impurities include beryllium, titanium, magnesium, and boron. Some of these elements are sometimes added during processing for specific purposes. For example, boron and iron can be used to further enhance the formation of equiaxed crystals and also diminish the dissimilarity of the diffusion rates of Ni and Sn in the matrix during solution heat treatment. Magnesium can serve as a deoxidizer. In the manufacturing processes of the present disclosure, these elements are ideally not used. For purposes of this disclosure, amounts of less than 0.01 wt % of these elements should be considered to be unavoidable impurities, i.e. their presence is not intended or desired. Some embodiments may additionally include iron and cobalt, but desirably do not. Some embodiments can contain up to 0.05 wt % iron and/or cobalt. However, preferred embodiments meet the performance and property characteristics, as disclosed herein, in the absence of these two elements.

The Cu—Ni—Si—Cr—Mn—Zr alloys of the present disclosure are processed to take advantage of multiple strengthening mechanisms. The alloys are cold worked and then solution annealed to keep grains small and fine. The alloys are then aged to bring out a variety of precipitates. Those precipitates can include Ni—Si precipitates, Cr—Zr—Si precipitates, and/or Cr—Ni—Mn—Si precipitates. The cold working creates a dislocation network that that causes the precipitates to come out on the grain boundaries, which locks in the fine grain size. The processes of the present disclosure generally comprise (1) cold working the Cu—Ni—Si—Cr—Mn—Zr alloy; (2) solution annealing the cold-worked alloy; and (3) aging the solution annealed alloy.

Cold working is a metal forming process typically performed near room temperature, in which an alloy is passed through rolls, dies, or is otherwise cold worked to reduce the section of the alloy and to make the section dimensions uniform. This increases the strength of the alloy. The degree of cold working performed is indicated in terms of % reduction in thickness, or % reduction in area, and is referred to in this disclosure as % CW. In the present processes, the alloy is provided as initially cast, and is then cold worked to a % CW of about 85% to about 95%.

Solution annealing involves heating a precipitation hardenable alloy to a high enough temperature to convert the microstructure into a single phase. A rapid quench to room temperature leaves the alloy in a supersaturated state that makes the alloy soft and ductile, helps regulate grain size, and prepares the alloy for aging. Subsequent heating of the supersaturated solid solution enables precipitation of the strengthening phase and hardens the alloy. In the present processes, after cold working, the cold-worked alloy is solution annealed at a temperature of about 900° C. to about 1000° C., or from about 900° C. to about 950° C., or from about 925° C. to about 975° C., or from about 950° C. to about 1000° C., or from about 925° C. to about 950° C., or from about 9750° C. to about 1000° C. The solution annealing may take place over a time period of about 5 minutes to about 20 minutes, or from about 5 minutes to about 15 minutes, or from about 5 minutes to about 10 minutes, or from about 10 minutes to about 20 minutes, or from about 10 minutes to about 15 minutes, or from about 15 minutes to about 20 minutes.

Aging is a heat treatment technique that produces ordering and fine particles (i.e. precipitates) of an impurity phase that impedes the movement of defects in a crystal lattice. This hardens the alloy. In the present processes, after solution annealing, the alloy is aged at a temperature of about 400° C. to about 460° C. (about 752° F. to about 860° F.), or from about 415° C. to about 460° C., or from about 430° C. to about 460° C., or from about 415° C. to about 445° C., or from about 445° C. to about 460° C. The aging may take place over a time period of about 6 hours to about 60 hours, or about 6 hours to about 30 hours, or about 6 hours to about 24 hours, or about 40 hours to about 56 hours, or about 6 hours to about 12 hours, or about 6 hours to about 18 hours It is noted that the aging can be performed in multiple steps, with the temperature of each step being within these stated ranges and the total time of the multiple steps being within these stated ranges. Desirably, the aging is performed in a 100% hydrogen atmosphere.

The resulting copper-nickel-silicon-chromium-manganese-zirconium (Cu—Ni—Si—Cr—Mn—Zr) alloy has a 0.2% offset yield strength of at least 80 ksi and an electrical conductivity of at least 48% IACS. In some embodiments, the alloy has a combination of a 0.2% offset yield strength of at least 82 ksi and an electrical conductivity of at least 49% IACS. The 0.2% offset yield strength is measured according to ASTM E8. In particular embodiments, the alloy has a 0.2% offset yield strength of at least 80 ksi to about 95 ksi, or at least 82 ksi, or at least 84 ksi. In some more specific embodiments, the alloy has an electrical conductivity of at least 48% IACS, or at least 49% IACS, or at least 50% IACS. In other embodiments, the alloy has an electrical conductivity of at least 48% IACS to about 55% IACS.

The Cu—Ni—Si—Cr—Mn—Zr alloys of the present disclosure also have an elastic modulus of at least 20 million psi (Msi). The elastic modulus is measured according to ASTM E111-17. The elastic modulus may go up to about 22 Msi. The Cu—Ni—Si—Cr—Mn—Zr alloys of the present disclosure may also have an ultimate tensile strength (UTS) of at least 88 ksi, or at least 90 ksi, or at least 92 ksi. The ultimate tensile strength is measured according to ASTM E8. The Cu—Ni—Si—Cr—Mn—Zr alloys of the present disclosure may also have a thermal conductivity of at least 200 W/m·K.

The Cu—Ni—Si—Cr—Mn—Zr alloys of the present disclosure may also have a % total elongation to break (% TE) of at least 5%, or at least 6%, or at least 8%, or at least 10%. This value measures how much the alloy can be stretched before it breaks, and is a rough indicator of formability. The % TE is also measured according to ASTM E8. Alternatively, the Cu—Ni—Si—Cr—Mn—Zr alloys of the present disclosure may have a ductility of at least 5% when measured at room temperature (22° C.). In more particular embodiments, the alloys have a ductility of at least 5% to about 15%.

The Cu—Ni—Si—Cr—Mn—Zr alloys of the present disclosure may alternatively have a formability ratio of 0.4/1 or lower. Good formability is usually measured by the formability ratio or R/t ratio. This specifies the minimum inside radius of curvature (R) that is needed to form a 90° bend in a strip of thickness (t) without failure, i.e. the formability ratio is equal to R/t. Materials with good formability have a low formability ratio (i.e. low R/t), in other words a lower R/t is better. The formability ratio can be measured using the 90° V-block test, wherein a punch with a given radii of curvature is used to force a test strip into a 90° die, and then the outer radius of the bend is inspected for cracks. The formability ratio can also be reported as the ratio of the formability in the longitudinal (good way) direction to the formability in the transverse (bad way) direction, or as GW/BW.

Any combination of the 0.2% offset yield strength, electrical conductivity, elastic modulus, ultimate tensile strength, % TE, ductility, and formability ratio discussed above is contemplated for the Cu—Ni—Si—Cr—Mn—Zr alloys of the present disclosure.

In particular embodiments, the Cu—Ni—Si—Cr—Mn—Zr alloys of the present disclosure have a 0.2% offset yield strength of at least 80 ksi, a conductivity of at least 48% IACS, a % TE of at least 10%, and a tensile modulus of at least 20 Msi.

In particular embodiments, the Cu—Ni—Si—Cr—Mn—Zr alloys of the present disclosure have a 0.2% offset yield strength of at least 80 ksi, a conductivity of at least 49% IACS, and a UTS of at least 90 ksi.

In particular embodiments, the Cu—Ni—Si—Cr—Mn—Zr alloys of the present disclosure have a 0.2% offset yield strength of at least 84 ksi, a conductivity of at least 49% IACS, a % TE of at least 8%, and a tensile modulus of at least 20 Msi.

In particular embodiments, the Cu—Ni—Si—Cr—Mn—Zr alloys of the present disclosure have a 0.2% offset yield strength of at least 80 ksi, a conductivity of at least 50% IACS, a % TE of at least 10%, and a tensile modulus of at least 20 Msi.

The Cu—Ni—Si—Cr—Mn—Zr alloys of the present disclosure have a combination of good yield strength and high electrical conductivity. The alloys can be provided as strip, wire, rod, tube, and bar. The alloys are also highly solderable and easily plated with other materials. Articles can be formed, for example, by stamping a strip into the desired shape of the final article or an intermediate shape that can be bent into the shape of the final article. The articles can be overcoated, for example with tin or gold or other materials, to provide additional desired properties, either before or after being formed.

The alloys can be used to make, for example, electrical connectors; electronic connectors, terminal contacts, or power contacts, where high strength and high electrical conductivity are desired. Examples of specific articles may include a heat sink in a cellphone; wiring harness terminals; electric vehicle charger contacts; high voltage/current/power terminal contacts; power connector contacts; midplane connectors; backplane connectors; card edge connectors; photovoltaic system connectors; appliance power contacts; computer power contacts; heat spreaders; bushing or bearing surfaces; and generally any component for an electronic device or an electrical device.

The following examples are provided to illustrate the alloys, processes, articles, and properties of the present disclosure. The examples are merely illustrative and are not intended to limit the disclosure to the materials, conditions, or process parameters set forth therein.

### EXAMPLES

### Example 1

A Cu—Ni—Si—Cr—Mn—Zr alloy was cast and processed as described above to obtain a strip with a width of about 15 inches. Its properties were measured at six (6) locations across the width of the inner and outer wraps, and then averaged. The values were 0.2% offset yield strength of 84.3 ksi, % TE of 10.4%, tensile modulus 21 Msi, and conductivity of 50.3% IACS. The R/t ratio was 0.4/1.

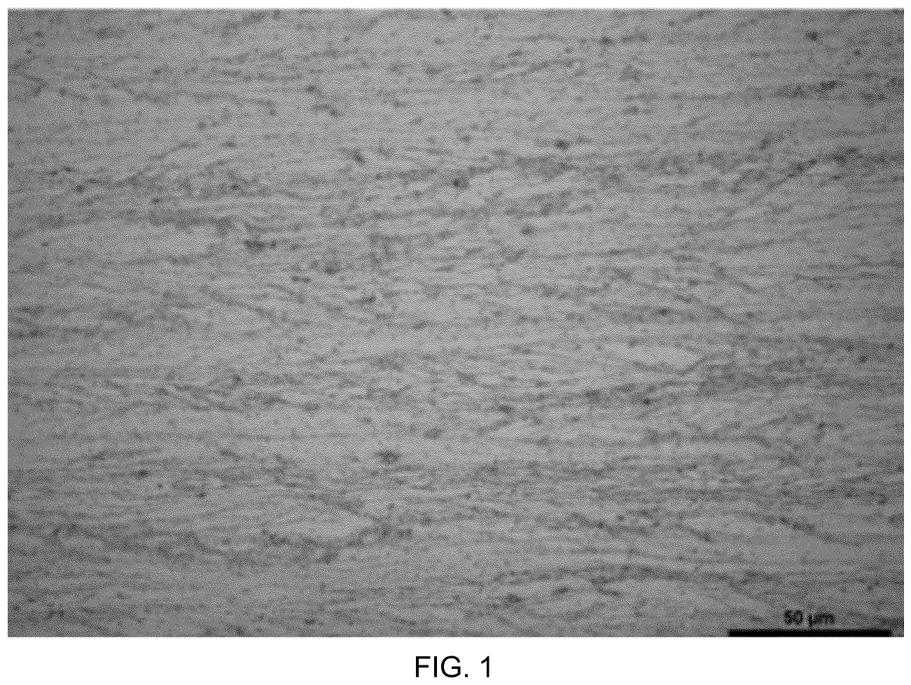

FIG. 1 is an optical image of the alloy after processing. Typical grains and some indications of work are visible. Some Ni—Cr silicides are visible.

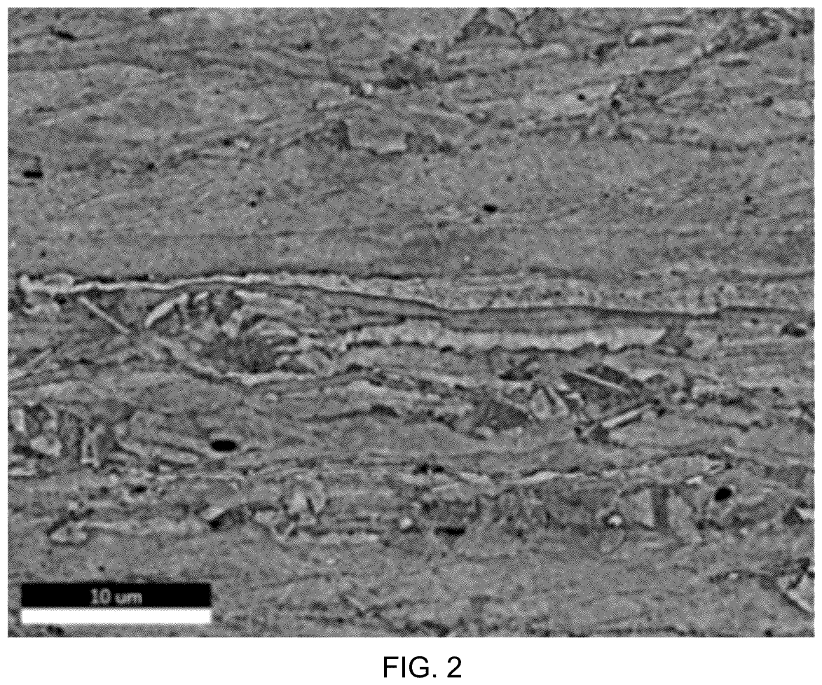

FIG. 2 is a BSE SEM image. The dark spots are Cr—Ni—Mn—Si silicides. These silicides have particle sizes on the order of about 100 nanometers to about 200 nm. Their presence is unique, and their small size is unusual. It is noted that these silicides are not visible in FIG. 1.

### Example 2

A Cu-1.23Ni-0.38Si-0.23Cr-0.08Mn-0.02Zr alloy was cast, cold worked to a % CW of about 85% to about 95%, solution annealed at a temperature of about 900° to about 1000° C., and then aged twice. The first aging was performed for 24 hours at either 800° F., 815° F., or 825° F. (427° C., 435° C., 441° C.). The second aging was performed for six hours at 800° F. (427° C.). The 0.2% offset yield strength (YS) and the electrical conductivity (% IACS) of the alloy were measured at various time points during the second aging, and are illustrated in three graphs.

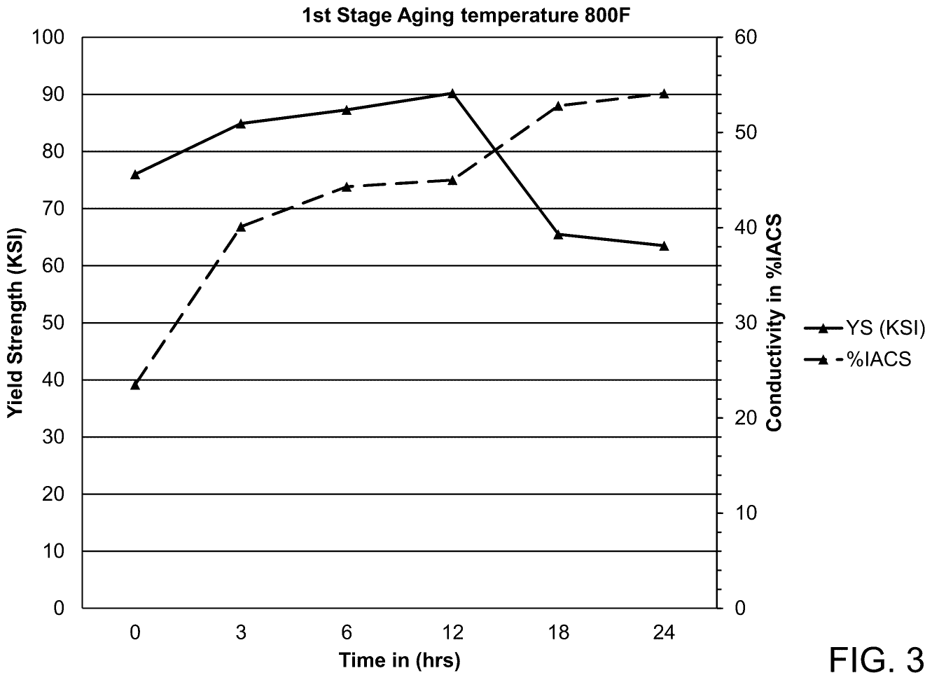

FIG. 3 shows the measured YS and % IACS during the second aging, when the first aging was at the temperature of 800° F. (427° C.). At about 12 hours into the second aging, the YS was 90.2 ksi and the conductivity was 45% IACS. After 18 hours, the YS had fallen to 65.5 ksi, but the conductivity had increased to 52.8% IACS.

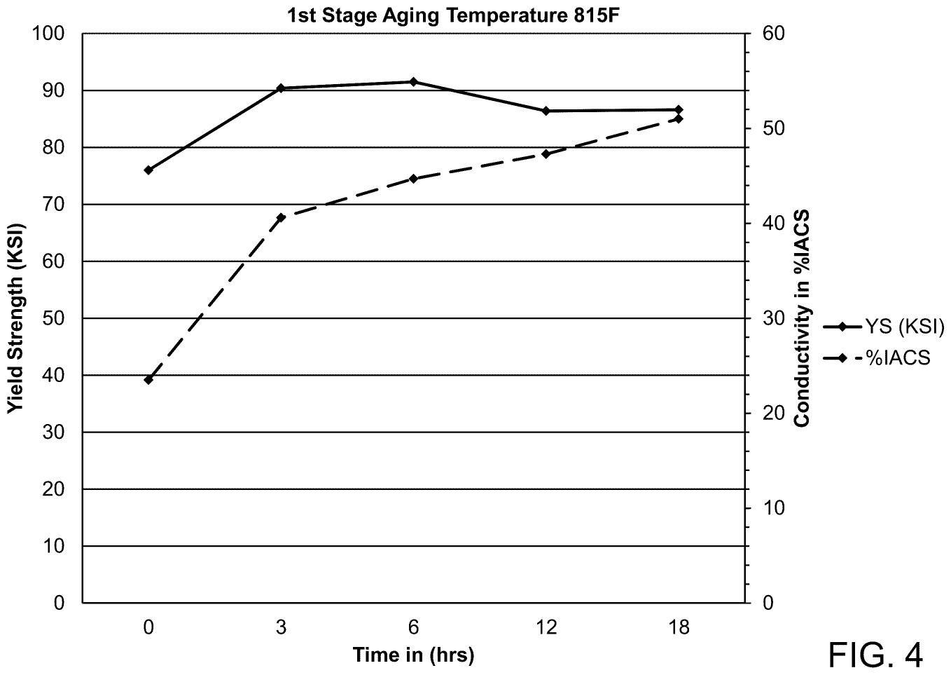

FIG. 4 shows the measured YS and % IACS during the second aging, when the first aging was at the temperature of 815° F. (435° C.). At 12 hours, the YS was 86.4 ksi and the conductivity was measured at 47.3% IACS. At 18 hours, the YS was 86.6 ksi and the conductivity was measured at 51% IACS.

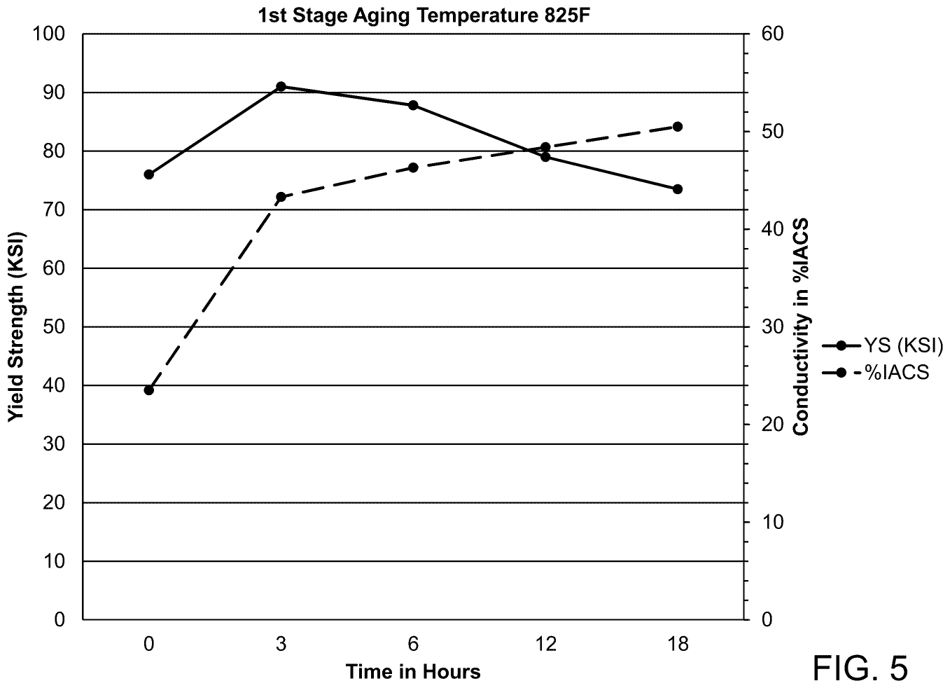

FIG. 5 shows the measured YS and % IACS during the second aging, when the first aging was at the temperature of 825° F. (441° C.). At 12 hours, the YS was 79 ksi and the conductivity was measured at 48.4% IACS. At 18 hours, the YS was 73.5 ksi and the conductivity was measured at 50.5% IACS.

Selected results for the tensile and conductivity tests are in Table 1 below. Longer aging at 800° F. resulted in higher conductivity as measured by % IACS and decreased 0.2% offset yield strength.

TABLE 1

| | Temp. | Time | UTS | YS | | | Resistivity |
|---|---|---|---|---|---|---|---|
| Alloy | (° F.) | (hours) | (ksi) | (ksi) | % TE | % IACS | (μΩ-cm) |
| Cu—Ni—Si—Cr—Mn—Zr | 800 | 12 | 96.1 | 89.8 | 7.88 | 43.6 | 3.96 |
| Cu—Ni—Si—Cr—Mn—Zr | 800 | 12 | 96.1 | 90.3 | 8.36 | 46.3 | 3.73 |
| Cu—Ni—Si—Cr—Mn—Zr | 800 | 18 | 78.2 | 65.4 | 11.39 | 52.9 | 3.26 |
| Cu—Ni—Si—Cr—Mn—Zr | 800 | 18 | 78.7 | 65.7 | 13.13 | 52.8 | 3.27 |
| Cu—Ni—Si—Cr—Mn—Zr | 800 | 24 | 75.8 | 62.6 | 12.33 | 54.8 | 3.15 |
| Cu—Ni—Si—Cr—Mn—Zr | 800 | 24 | 78 | 64.4 | 12.31 | 53.4 | 3.23 |
| Cu—Ni—Si—Cr—Mn—Zr | 815 | 3 | 94.6 | 90.5 | 7.27 | 40.6 | 4.24 |
| Cu—Ni—Si—Cr—Mn—Zr | 815 | 3 | 94.4 | 90.4 | 6.81 | 40.5 | 4.25 |
| Cu—Ni—Si—Cr—Mn—Zr | 815 | 6 | 96.5 | 91.3 | 8.07 | 45.0 | 3.84 |
| Cu—Ni—Si—Cr—Mn—Zr | 815 | 6 | 97 | 91.8 | 7.8 | 44.4 | 3.88 |
| Cu—Ni—Si—Cr—Mn—Zr | 815 | 12 | 93.3 | 86.4 | 9.31 | 47.3 | 3.65 |
| Cu—Ni—Si—Cr—Mn—Zr | 815 | 12 | 93.6 | 86.3 | 6.71 | 47.3 | 3.64 |
| Cu—Ni—Si—Cr—Mn—Zr | 815 | 18 | 76.2 | 62 | 13.15 | 48.7 | 3.54 |
| Cu—Ni—Si—Cr—Mn—Zr | 815 | 18 | 88.9 | 79.9 | 9.53 | 53.8 | 3.20 |
| Cu—Ni—Si—Cr—Mn—Zr | 825 | 18 | 70.8 | 56.6 | 14.374 | 51.7 | 3.33 |
| Cu—Ni—Si—Cr—Mn—Zr | 825 | 18 | 84.8 | 75.1 | 10.64 | 49.3 | 3.49 |

### Example 3

A chemical analysis was performed to determine the composition of a Cu—Ni—Si—Cr—Mn—Zr alloy as used herein. The analysis indicated a composition of: <0.01 wt % beryllium, 0.01 wt % cobalt, 1.22 wt % nickel, 0.02 wt % iron, 0.38 wt % silicon, <0.01 wt % aluminum, <0.01 wt % tin, <0.01 wt % zinc, 0.23 wt % chromium, <0.01 wt % lead, 0.08 wt % manganese, 0.02 wt % zirconium, and balance copper. Amounts listed are reported to the hundredths decimal place. Thus, rounding may affect reported amounts of each element as listed herein.

### Example 4

Strips of the Cu—Ni—Si—Cr—Mn—Zr alloy described in Example 3 were rolled to about 0.008 inches. The alloy strips were then aged at approximately 850° F. for three hours. Ultimate tensile strength (UTS) in ksi, 0.2% offset yield strength (YS) in ksi, percent elongation to break (% TE), conductivity (measured by % IACS and resistivity), and hardness were assessed for the Cu—Ni—Si—Cr—Mn—Zr alloy, as well as three other copper alloys: C18150 (Cu-1.0Cr-0.25Zr); C18140M (Cu-0.6Cr-0.1Ag-0.1Ni-0.07Si); and C18070 (Cu-0.7Cr-0.1Ag-0.05Ti-0.02Si). The results are outlined in Table 2 below. The Cu—Ni—Si—Cr—Mn—Zr alloy had improved tensile strength and 0.2% offset yield strength when compared with the other alloys tested. The alloy of the present disclosure also had increased resistivity and hardness compared with the other alloys.

TABLE 2

| | | | | | | Avg. |
|---|---|---|---|---|---|---|
| | UTS | YS | | | Resistivity | Hardness |
| Alloy | (ksi) | (ksi) | % TE | % IACS | (μΩ-cm) | (HV) |
| C18150 | 66.5 | 61.2 | 4.31 | 57.7 | 2.99 | |
| C18150 | 65.3 | 63.4 | 1.331 | 66.3 | 2.6 | 153.0 |
| C18140M | 64.2 | 60.2 | 5.09 | 68.9 | 2.5 | |
| C18140M | 62.4 | 58.1 | 5.44 | 72.4 | 2.38 | 153.6 |
| Cu—Ni—Si—Cr—Mn—Zr | 74.8 | 69.8 | 3.17 | 45.8 | 3.76 | |
| Cu—Ni—Si—Cr—Mn—Zr | 77.1 | 73.8 | 1.824 | 41.0 | 4.21 | 196.0 |
| C18070 | 69.5 | 66.3 | 3.51 | 72.8 | 2.37 | |
| C18070 | 66.6 | 63.5 | 2.51 | 72.5 | 2.38 | 160.3 |

### Example 5

Samples of C18140M (Cu-0.6Cr-0.1Ag-0.1Ni-0.07Si) alloy, Cu—Ni—Si—Cr—Mn—Zr (composition amounts in Example 3), C18070 (Cu-0.7Cr-0.1Ag-0.05Ti-0.02Si) alloy, and C18150 (Cu-1.0Cr-0.5Zr) alloy were cold-worked to a % CW of about 70%. Ultimate tensile strength, 0.2% offset yield, and % elongation were measured at room temperature. Each alloy was in the form of a long strip, which was coiled up. Measurements were taken at the inner diameter (ID) and the outer diameter (OD) of each strip, corresponding to the beginning of the casting run (ID) and the end of the casting run (OD). The results of these tests are listed in Table 3 below. After annealing, the alloy of the present disclosure had an ultimate tensile strength greater than that of the other alloys except the Cu-1.0Cr-0.5Zr ID alloy. The yield strength and percent elongation were also similar to the other alloys post-annealing.

The alloys were then aged in a furnace at 850° F. for three hours. The samples were water quenched upon removal from the furnace. Results of strength and conductivity testing is listed in Table 3. All alloys had improved ultimate tensile strength when rolled and aged as compared to post-annealing. The Cu—Ni—Si—Cr—Mn—Zr alloy had the highest tensile strength as compared with the other alloys. The alloy also had the lowest % IACS and highest resistivity compared with the other alloys. The alloy of the present disclosure was the only alloy to exhibit 0.2% offset yield strength of at least 80 ksi.

TABLE 3

| | | UTS | YS | | | Resistivity |
|---|---|---|---|---|---|---|
| Alloy | Condition | (ksi) | (ksi) | % TE | % IACS | (μΩ-cm) |
| C18140M ID | Annealed | 38.8 | 11.02 | 43.0 | | |
| C18140M OD | Annealed | 39.2 | 35.7 | 48.0 | | |
| C18140M | Rolled/Aged | 70.7 | 65.2 | 9.46 | 77.4 | 2.23 |
| C18140M | Rolled/Aged | 70.9 | 65.1 | 9.16 | 73.1 | 2.36 |
| Cu—Ni—Si—Cr—Mn—Zr ID | Annealed | 42.4 | 12.23 | 39.4 | | |
| Cu—Ni—Si—Cr—Mn—Zr OD | Annealed | 42.1 | 11.7 | 39.2 | | |
| Cu—Ni—Si—Cr—Mn—Zr | Rolled/Aged | 88.8 | 82.6 | 7.94 | 44.3 | 3.89 |
| Cu—Ni—Si—Cr—Mn—Zr | Rolled/Aged | 89.3 | 82.8 | 8.22 | 39.7 | 4.34 |
| C18070 ID | Annealed | 39.9 | 12.12 | 42.8 | | |
| C18070 OD | Annealed | 39.0 | 10.85 | 33.5 | | |
| C18070 | Rolled/Aged | 74.3 | 68.9 | 8.05 | 76.9 | 2.24 |
| C18070 | Rolled/Aged | 75.2 | 69.4 | 9.54 | 75.7 | 2.28 |
| C18150 ID | Annealed | 54.5 | 15.3 | 40.0 | | |
| C18150 OD | Annealed | 32.7 | 9.8 | 41.3 | | |
| C18150 | Rolled/Aged | 76.6 | 70.8 | 10.82 | 65 | 2.65 |
| C18150 | Rolled/Aged | 75.1 | 69.3 | 10.24 | 60.5 | 2.85 |

Hardness of each alloy was also assessed using the Rockwell Hardness 15T Test (15T) and the Vickers Hardness Test (HV). Results are listed in Table 4 below. After annealing, the alloy of the present disclosure had a similar average hardness, as measured by the Rockwell 15T Scale, as the C18150 (Cu-1.0Cr-0.5Zr) alloy. As measured by the Vickers Hardness Test, the Cu—Ni—Si—Cr—Mn—Zr alloy had the highest average hardness post-annealing (as compared with the other alloys post-annealing), and after rolling and aging (as compared with the other alloys after rolling and aging).

TABLE 4

| | | Avg. | Avg. |
|---|---|---|---|
| | | Hardness | Hardness |
| Alloy | Condition | (15T) | (HV) |
| C18140M | Annealed | 51.9 | 88.5 |
| C18140M | Rolled/Aged | | 159.7 |
| Cu—Ni—Si—Cr—Mn—Zr | Annealed | 57.4 | 100.0 |
| Cu—Ni—Si—Cr—Mn—Zr | Rolled/Aged | | 199.8 |
| C18070 | Annealed | 52.3 | 89.8 |
| C18070 | Rolled/Aged | | 168.3 |
| C18150 | Annealed | 58.3 | 92.7 |
| C18150 | Rolled/Aged | | 177.5 |

### Example 6

Four samples of the Cu—Ni—Si—Cr—Mn—Zr (composition amounts in Example 3) alloy were placed in a furnace at 800° F. After three hours, two of the samples were removed from the furnace and water quenched. The other two samples were removed from the furnace after a total of six hours and subsequently water quenched. Several properties were assessed after processing and aging, including ultimate tensile strength, yield strength, % TE, % IACS, hardness, and resistivity. Results of these tests are in Table 5 below. Aging the alloy for six hours resulted in ultimate tensile strength measurements of 93.3 and 92.8 ksi, 0.2% offset yield measurements of 87.5 and 87.2 ksi, and average hardness of 198.9 HV. Additionally, six hours of aging resulted in the alloy having resistivity measurements of 3.91 μΩ-cm and 3.88 μΩ-cm.

TABLE 5

| | | | | | | | Avg. | |
|---|---|---|---|---|---|---|---|---|
| | Temp. | Time | UTS | YS | | | Hardness | Resistivity |
| Alloy | (° F.) | (hours) | (ksi) | (ksi) | % TE | % IACS | (HV) | (μΩ-cm) |
| Cu—Ni—Si—Cr—Mn—Zr | 800 | 3 | 89.4 | 84.5 | 7.02 | 40.5 | | 4.26 |
| Cu—Ni—Si—Cr—Mn—Zr | 800 | 3 | 90.8 | 85.2 | 7.77 | 39.7 | 187.1 | 4.34 |
| Cu—Ni—Si—Cr—Mn—Zr | 800 | 6 | 93.3 | 87.5 | 8.02 | 44.1 | | 3.91 |
| Cu—Ni—Si—Cr—Mn—Zr | 800 | 6 | 92.8 | 87.2 | 7.63 | 44.5 | 198.9 | 3.88 |

### Example 7

Six samples of the Cu—Ni—Si—Cr—Mn—Zr (composition amounts in Example 3) alloy were placed in a furnace at 825° F. Two samples were removed at each of the intervals of three, six, and twelve hours and water quenched upon removal. Several properties were assessed including ultimate tensile strength, yield strength, elongation, % IACS, hardness, and resistivity. Results for these tests are listed in Table 6 below. Ultimate tensile strength and yield strength tended to decrease with longer aging. % IACS tended to increase with longer aging. After aging 6 hours, the alloy had the highest average hardness as measured by the Vickers Hardness Test. Resistivity tended to decrease with longer aging.

TABLE 6

| | | | | | | | Avg. | |
|---|---|---|---|---|---|---|---|---|
| | Temp. | Time | UTS | YS | | | Hardness | Resistivity |
| Alloy | (° F.) | (hours) | (ksi) | (ksi) | % TE | % IACS | (HV) | (μΩ-cm) |
| Cu—Ni—Si—Cr—Mn—Zr | 825 | 3 | 95.9 | 91 | 7.43 | 43.1 | | 4.00 |
| Cu—Ni—Si—Cr—Mn—Zr | 825 | 3 | 96 | 91 | 9.06 | 43.7 | 197.1 | 3.94 |
| Cu—Ni—Si—Cr—Mn—Zr | 825 | 6 | 94 | 87.2 | 9.8 | 46.5 | | 3.71 |
| Cu—Ni—Si—Cr—Mn—Zr | 825 | 6 | 94.7 | 88.3 | 8.16 | 46.1 | 205.3 | 3.74 |
| Cu—Ni—Si—Cr—Mn—Zr | 825 | 12 | 88.9 | 79.6 | 10.41 | 48.5 | | 3.55 |
| Cu—Ni—Si—Cr—Mn—Zr | 825 | 12 | 92.9 | 78.4 | 9.1 | 48.2 | 197.2 | 3.58 |

### Example 8

Four samples of the Cu—Ni—Si—Cr—Mn—Zr (composition amounts in Example 3) alloy were cold worked and annealed. The samples were placed in a furnace at 825° F. for six hours. Then, the furnace temperature was lowered to 800° F., which took 30 minutes to 60 minutes. Two of the samples remained in the furnace for an additional six hours after the 825° F. heating, totaling twelve hours time-in-furnace. The remaining two samples remained in the furnace for twelve hours after the 825° F. heating, totaling eighteen hours time-in-furnace. Tensile strength, hardness (average of five measurements), and conductivity were assessed and the results are listed in Table 7 below. At 12 hours aging, the alloy had 0.2% offset yield strength measurements of 83.1 ksi and 83.3 ksi; the alloy had conductivity of 49.3% IACS and 49.1 IACS. Longer aging tended to result in lower ultimate tensile strength, yield strength, and hardness. Eighteen hours of aging resulted in increased resistivity and percent elongation as compared with 12 hours. At both 12 and 18 hours of aging, the alloy had greater than 48% IACS.

TABLE 7

| | | | | | | Avg. | |
|---|---|---|---|---|---|---|---|
| | Time | UTS | YS | | | Hardness | Resistivity |
| Alloy | (hours) | (ksi) | (ksi) | % TE | % IACS | (HV) | (μΩ-cm) |
| Cu—Ni—Si—Cr—Mn—Zr | 12 | 91.2 | 83.1 | 9.69 | 49.3 | | 3.50 |
| Cu—Ni—Si—Cr—Mn—Zr | 12 | 91.7 | 83.3 | 9.39 | 49.1 | 199.1 | 3.51 |
| Cu—Ni—Si—Cr—Mn—Zr | 18 | 86.9 | 76.8 | 10.06 | 48.7 | | 3.54 |
| Cu—Ni—Si—Cr—Mn—Zr | 18 | 87.1 | 77.4 | 9.9 | 51.6 | 187.9 | 3.34 |

### Example 9

Four samples of each of C18140M (Cu-0.Cr-0.1Ag-0.1Ni-0.07Si), C18070 (Cu-0.7Cr-0.1Ag-0.05Ti-0.02Si), and C18150 (Cu-1.0Cr-0.25Zr) alloys were cut. Conductivity and tensile measurements were taken on the as-received alloys. The remaining samples were then heated for three hours at 825° F. Tensile strength and conductivity measurements were then taken on these samples. Results of these tests are listed in Table 8 below. None of the alloys tested had a 0.2% offset yield strength of at least 80 ksi. Only after aging did the alloys have a conductivity of at least 48% IACS.

TABLE 8

| | Temp. | Time | UTS | YS | | | Resistivity |
|---|---|---|---|---|---|---|---|
| Alloy | (° F.) | (hours) | (ksi) | (ksi) | % TE | % IACS | (μΩ-cm) |
| C18140M ID | N/A | N/A | 67.2 | 64.8 | 1.432 | 39.2 | 4.4 |
| C18140M OD | N/A | N/A | 68 | 65.3 | 1.375 | 40.7 | 4.24 |
| C18070 ID | N/A | N/A | 69.2 | 66.8 | 1.573 | 32.7 | 5.27 |
| C18070 OD | N/A | N/A | 72.6 | 66.4 | 1.766 | 34.5 | 5.00 |
| C18150 | N/A | N/A | 72.9 | 69.4 | 1.843 | 34.5 | 5.00 |
| C18150 | N/A | N/A | 71.3 | 68 | 2.09 | 34.2 | 5.03 |
| C18140M | 825 | 3 | 73 | 67.9 | 7.79 | 69.6 | 2.48 |
| C18140M | 825 | 3 | 74.2 | 68.5 | 6.7 | 76.2 | 2.26 |
| C18070 | 825 | 3 | 78.7 | 74.8 | 7.6 | 76.9 | 2.24 |
| C18070 | 825 | 3 | 78.1 | 73.4 | 7.99 | 70.7 | 2.44 |
| C18150 | 825 | 3 | 78.2 | 73.6 | 8.44 | 69.6 | 2.48 |
| C18150 | 825 | 3 | 78.3 | 73.7 | 8.48 | 64.4 | 2.68 |

### Example 10

Two samples of C18070 (Cu-0.7Cr-0.1Ag-0.05Ti-0.02Si) alloy of approximately 0.008 inch thickness were heat treated for six hours. One of the samples was heat treated at 825° F. The other sample was heat treated at 800° F. Upon removal from the furnace, both were water quenched, and their tensile and conductivity properties were assessed.

Eight samples of C18150 (Cu-1.0Cr-0.25Zr) alloy were taken and heat treated as follows: two were heated at 900° F. for one hour and water quenched; two were heated at 900° F. for two hours and water quenched; two were heated at 925° F. for one hour and water quenched; two were heated at 925° F. for two hours and water quenched. Conductivity and tensile measurements were taken. The results are summarized in Table 9 below. None of the alloys tested had a 0.2% offset yield strength of at least 80 ksi. All alloys tested had a conductivity greater than 48% IACS.

TABLE 9

| | Temp. | Time | UTS | YS | | | Resistivity |
|---|---|---|---|---|---|---|---|
| Alloy | (° F.) | (hours) | (ksi) | (ksi) | % TE | % IACS | (μΩ-cm) |
| C18070 | 825 | 6 | 75.5 | 72.5 | 9.79 | 79.0 | 2.18 |
| C18070 | 800 | 6 | 75.1 | 72 | 8.29 | 80.8 | 2.13 |
| C18150 | 900 | 1 | 77.3 | 71.8 | 8.93 | 63.0 | 2.74 |
| C18150 | 900 | 1 | 78.2 | 72.8 | 9.63 | 64.9 | 2.66 |
| C18150 | 900 | 2 | 76 | 69.9 | 9.24 | 64.2 | 2.69 |
| C18150 | 900 | 2 | 75 | 68.7 | 9.62 | 66.6 | 2.59 |
| C18150 | 925 | 1 | 75.6 | 69.6 | 10.51 | 61.9 | 2.79 |
| C18150 | 925 | 1 | 75.1 | 69.1 | 8.64 | 65.6 | 2.63 |
| C18150 | 925 | 2 | 71.1 | 63.8 | 9 | 66.4 | 2.60 |
| C18150 | 925 | 2 | 71.3 | 63.9 | 10.11 | 62.7 | 2.75 |

### Example 11

Strips comprising from about 1.2 wt % to about 1.4 wt % nickel; from about 0.3 wt % to about 4 wt % silicon; from about 0.3 wt % to about 0.4 wt % chromium; from about 0.08 wt % to about 0.12 wt % manganese; from about 0.02 wt % to about 0.06 wt % zirconium; and balance copper were made according to the present disclosure and tested.

The alloys were cold worked and annealed. The samples were placed in a furnace at 825° F. for six hours. Then, the furnace temperature was lowered to 800° F., which took 30 minutes to 60 minutes. The samples were then heated for an additional six hours after the 825° F. heating, totaling twelve hours time-in-furnace. The ultimate tensile strength (UTS), 0.2% offset yield strength (YS), total elongation to break (% TE), elastic modulus (EM), electrical conductivity (% IACS) Several properties were measured (UTS, Yield Strength, and the formability in both directions (GW, BW). The results are listed in Table 10 below, as well as the gauge for each strip.

TABLE 10

| | Gauge | UTS | YS | | EM | | | |
|---|---|---|---|---|---|---|---|---|
| Alloy | (in) | (ksi) | (ksi) | % TE | (Msi) | % IACS | GW | BW |
| Cu—Ni—Si—Cr—Mn—Zr | 0.0315 | 96.6 | 89.5 | 9.7 | 21.4 | 49.5 | 0.10 | 0.30 |
| Cu—Ni—Si—Cr—Mn—Zr | 0.0236 | 97.2 | 89.5 | 9.7 | 20.5 | 49.0 | 0.10 | 0.50 |
| Cu—Ni—Si—Cr—Mn—Zr | 0.00787 | 93.7 | 84.4 | 10 | | 50 | 0.5 | 0.5 |
| Cu—Ni—Si—Cr—Mn—Zr | 0.00787 | 91.1 | 85.0 | 8.2 | 21.8 | 50.3 | 0.0 | 0.0 |

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1-11. (canceled)

12. A process for making a copper alloy that does not contain beryllium and has a 0.2% offset yield strength of at least 80 ksi and a conductivity of at least 48% IACS, comprising:
cold working a copper-nickel-silicon-chromium-manganese-zirconium alloy to a percentage of cold working (% CW) of about 80% to about 95%;
solution annealing the cold-worked copper-nickel-silicon-chromium-manganese-zirconium alloy; and
aging the solution-annealed copper-nickel-silicon-chromium-manganese-zirconium alloy to obtain the copper alloy with a 0.2% offset yield strength of at least 80ksi and a conductivity of at least 48% IACS;
wherein the copper-nickel-silicon-chromium-manganese-zirconium alloy comprises about 1.0 wt % to 2.0 wt % nickel; about 0.2 wt % to about 1.0 wt % silicon;
about 0.1 wt % to about 0.4 wt % chromium; about 0.05 wt % to 0.2 wt % manganese;
about 0.01 wt % to 0.15 wt % zirconium; and the balance copper.

13. The process of claim 12, wherein the solution annealing is performed at a temperature of about 900° C. to about 1000° C. for a time period of about 5 minutes to about 20minutes.

14. The process of claim 12, wherein the aging is performed at a temperature of about 400°° C. to about 460° C. for a time period of about 6 hours to about 60hours.

15. The process of claim 12, wherein the aging is performed at a temperature of about 400°° C. to about 460° C. for a time period of about 6 hours to about 18hours.

16-19. (canceled)

20. A process of using a copper-nickel-silicon-chromium-manganese-zirconium alloy that has a 0.2% offset yield strength of at least 80 ksi and a conductivity of at least 48% IACS, comprising:
stamping an article from a strip of the copper-nickel-silicon-chromium-manganese-zirconium alloy, wherein the copper-nickel-silicon-chromium-manganese-zirconium alloy comprises about 1.0 wt % to 2.0 wt % nickel; about 0.2 wt % to about 1.0 wt % silicon; about 0.1 wt % to about 0.4 wt % chromium; about 0.05 wt % to 0.2 wt % manganese; about 0.01 wt % to 0.15 wt % zirconium; and the balance copper.

21. The process of claim 12, wherein the aging is performed at a temperature of about 435° C. for a time period of about 18 hours.

22. The process of claim 12, wherein the wherein the copper-nickel-silicon-chromium-manganese-zirconium alloy comprises about 1.2 wt % to about 1.4 wt % nickel; about 0.3 wt % to about 0.4 wt % silicon; about 0.3 wt % to about 0.4 wt % chromium; about 0.08 wt % to about 0.12 wt % manganese; about 0.02 wt % to about 0.06 wt % zirconium; and balance copper.

23. The process of claim 12, wherein the copper-nickel-silicon-chromium-manganese-zirconium alloy does not contain beryllium, titanium, iron, cobalt, magnesium, or boron.

24. The process of claim 12, wherein the copper-nickel-silicon-chromium-manganese-zirconium alloy has an ultimate tensile strength of at least 88 ksi.

25. The process of claim 12, wherein the copper-nickel-silicon-chromium-manganese-zirconium alloy has an elastic modulus of at least 20 million psi.

26. The process of claim 12, wherein the copper-nickel-silicon-chromium-manganese-zirconium alloy has a % total elongation of at least 8%.

27. The process of claim 12, wherein the copper-nickel-silicon-chromium-manganese-zirconium alloy has a formability ratio of 0.4/1 or lower, wherein the formability ratio is measured using the 90 V-block test and the formability ratio is formability in the longitudinal direction to the formability in the transverse direction.

28. The process of claim 12, wherein the copper-nickel-silicon-chromium-manganese-zirconium alloy contains silicides, the silicides being formed from silicon, chromium, nickel, and manganese.

29. The process of claim 12, wherein the copper-nickel-silicon-chromium-manganese-zirconium alloy has a 0.2% offset yield strength of at least 80 ksi, a conductivity of at least 48% IACS, and a % TE of at least 8%.

30. The process of claim 12, wherein the copper-nickel-silicon-chromium-manganese-zirconium alloy has a 0.2% offset yield strength of at least 80 ksi, a conductivity of at least 49% IACS; and a UTS of at least 90 ksi.
